(19) United States
(12) Patent Application Publication
(10) Pub. No.: US 2011/0067995 A1
(43) Pub. Date: Mar. 24, 2011

(54) Ethanol Distillation System and Apparatus

(76) Inventor: James D. Lusk, Las Vegas, NV (US)

(21) Appl. No.: 12/565,111

(22) Filed: Sep. 23, 2009

(51) Int. Cl. B01D 3/00; C02F 3/32; B01D 19/00; F28D 15/00

(52) U.S. Cl. 203/90; 210/602; 202/262; 210/188; 165/104.19

(57) ABSTRACT

An apparatus and method is disclosed which provides for an increased efficiency and reduced waste in an ethanol production facility. One aspect involves a burner assembly with a heat moderating material used in heating for distillation. Another aspect involves atomizing distillant for improved heat absorption in a distillation tank. Yet another aspect involves the utilization of waste products for growing plants in a hydroponics garden.

### BACKGROUND

Ethanol is currently used as a fuel for combustion engines either in a blended form with another substance such as gasoline or in a more pure form. Ethanol can be produced using petroleum based substances such as coal and through renewable energy sources such as carbon based plants. Interest in ethanol production has increased in the last few years because it is a sustainable energy source and because of a trend toward an increase in fossil fuel prices.

Common plants, or feedstock, used for ethanol production include corn, potatoes, sorghum, sugar cane and others. These plants are high in starch and sugars and are readily converted to simple sugars for producing ethanol. Plants such as these can be grown in large or small acreages in a variety of climates. All of the foregoing characteristics make these, and other, plants suitable for use in ethanol production. In many instances, the ethanol production facility is located near the source of the feedstock to reduce shipping costs of these raw materials.

A conventional ethanol production starts with milling the feedstock in a wet or dry process. Wet milling is used to break the feedstock kernels down into germ, fiber, protein and starch components. Dry milling is used to grind the feedstock kernels down into a flour consistency. Undesired contaminants are also removed from the feedstock material during this process.

Following the milling process, the milled feedstock is mixed with water, an enzyme is added and the pH is adjusted to optimize the enzyme function. The enzyme is used to break down the starch in the feedstock and the solution is usually heated in one or more steps to assist in the break down of the feedstock. After a time, a second enzyme can be added to the mixture and the pH again adjusted. This second enzyme further breaks down the feedstock into simple sugars.

After the addition of the second enzyme, the solution is transferred to a fermentation tank. Yeast is added to the mixture and over time the yeast converts the simple sugars to ethanol and carbon dioxide through fermentation. Typically, fermentation is allowed to continue for several days. The resulting mixture is referred to herein as distillant and contains about 15% ethanol as well as stillage consisting of waste water and solids from the feedstock and the yeast.

The distillant is pumped from the fermentation tank to a distillation column where the distillant is heated. The distillant is heated to boil off the ethanol from the water. The ethanol and water have different boiling temperatures, the ethanol starts to boil off at about 174 degrees Fahrenheit while the boiling point of water is about 212 degrees Fahrenheit. By maintaining the temperature in the distillation column above the ethanol boiling point and below the water boiling point, the ethanol is vaporized and rises to the top of the distillation column where it is removed and collected.

Conventionally, the distillant is supplied to the distillation column in a liquid form at a point that is approximately vertically centered. The distillant runs down from the supply to the bottom of the column where the heat is supplied. In some instances, the heat is supplied to the distillant by removing the distillant from the bottom of the column, passing the distillant through a heat exchanger and reintroducing the distillant into the column above the liquid level at the bottom of the column. This process can use steam to heat the distillant. In some instances, the heat exchanger is positioned in the bottom of the column where it is submerged in the distillant.

Heat can be provided for the distillation tank from a number of fuels, such as propane, natural gas, electric and others. Fuel to provide heat is a large factor in considering the overall cost for the production of ethanol. For this reason, reducing fuel consumption for a given amount of ethanol production is a primary concern with making ethanol price competitive for consumer use.

The distilled ethanol typically reaches 95% purity through the distillation process in the distillation tank. Dehydration can be used to further purify the ethanol by removing the remaining 5% water if desired.

Carbon dioxide and stillage are also produced during the production of the ethanol. In the conventional ethanol production facility, the carbon dioxide is either released into the atmosphere or is captured and sold for use in carbonating beverages or other uses. Typically, smaller production facilities avoid the cost of collection systems and simply release the carbon dioxide.

Typically, the stillage water and solids are separated to some degree and some of the water with relatively lower solid content can be re-used in the production process. The remainder of the water with relatively higher solid content typically is considered as waste and is disposed. What are considered solids are the remnants of the feedstock and the yeast and at this point the solids still contain. The solids are often collected and used for animal feed applications. These solids are either sold as a wet distillers grain or dry distillers grain depending on whether the majority of the remaining water has been removed.

The present invention provides a highly advantageous distillation device and method that are submitted to offer solutions to problems and concerns related to conventional ethanol production methods while providing still further advantages, as described hereinafter.

### SUMMARY OF THE INVENTION

The present invention overcomes limitations of conventional ethanol production facilities by increasing efficiency and reducing waste.

In one embodiment, according to the present disclosure, a method of ethanol production is described in an ethanol production facility in which a sugar containing raw material is fermented to produce a distillant containing ethanol and stillage. The distillant is introduced into a distillation tank where heat is applied to the distillant to remove ethanol from the distillant by vaporizing the ethanol which is then removed from the distillation tank. The method increases the amount of ethanol that is removed from the distillant for a given amount of heat applied in the distillation tank. The distillant is sprayed into the distillation tank to cause the distillant to be separated into droplets which have an increased surface area per volume relative to a non-sprayed distillant of the same volume. The increased surface area of the droplets causes an increase in the absorption of the applied heat relative to the non-sprayed distillant thereby increasing the amount of ethanol that is separated from the distillant for a given amount of heat applied in the distillation tank.

Another embodiment involves a method for reducing waste from an ethanol production facility in which a sugar containing raw material is fermented to produce ethanol. The ethanol production also produces waste materials including carbon dioxide, and stillage including waste water and solids. At least one hydroponics garden is positioned in a location near the ethanol production facility. The hydroponics garden includes a structure that is at least partially enclosed and which contains plants arranged with roots that are at least partially immersed in a root immersion water. At least a portion of the carbon dioxide produced by fermentation is directed into the hydroponics structure for use by the plants during photosynthesis and at least a portion of the stillage waste water is transferred to the hydroponics garden for use as the root immersion water.

Another embodiment involves a method for heating a distillation tank in an ethanol production facility. In this method, a burner assembly is configured for burning a fuel to produce heat. Heat tubing is arranged at least to provide fluid communication between the burner assembly and the distillation tank. The heat tubing having a tubing wall and defining a through passage. A first portion of the heat tubing is positioned in the distillation tank and another, second portion of the heat tubing is positioned in the burner assembly. The heat tubing is filled with a heat transfer oil for receiving heat from the burner assembly transferred through the tubing wall of the second portion of the tubing and for transferring the heat to the distillation tank via said through passage. Heat is transferred into the distillation tank by passing through the tubing wall of the first portion of tubing. An oil pump is arranged for pumping the heat transfer oil through the through passage to circulate in the through passage. A heat moderating material is positioned in the burner assembly in a position to at least partially surround the second portion of the heat tubing. The heat moderating material has a characteristic which causes the heat from the burned fuel to be moderated by distributing the heat in the moderating material and transferring a portion of the heat through the moderating material to the surrounded heat tubing and the heat transfer oil within the surrounded heat tubing.

### BRIEF DESCRIPTION OF THE DRAWINGS

FIG. 1 is a diagrammatic view, in elevation, of a portion of an ethanol production facility incorporating a burner assembly having a heat moderating material.

FIG. 2 is an enlarged and detailed view of the burner assembly shown in FIG. 1 showing the heat moderating material and a heat absorber coil.

FIG. 3 is an enlarged perspective view of the heat absorber coil shown in FIG. 2.

FIG. 4 is a perspective view of a heat transfer portion of a stillage removal pipe shown in FIG. 1.

FIG. 5 is an enlarged and detailed view of a heat exchanger shown in FIG. 1.

FIG. 6 is a diagrammatic view, in elevation, of a distillation tank for use in an ethanol production facility.

FIG. 7 is a diagrammatic view, in elevation, of a portion of an ethanol production facility which incorporates a hydroponics garden to for waste management.

### DETAILED DESCRIPTION OF THE INVENTION

While this invention is susceptible to embodiment in many different forms, there are shown in the drawings, and will be described herein in detail, specific embodiments thereof with the understanding that the present disclosure is to be considered as an exemplification of the principles of the invention and is not to be limited to the specific embodiments described. Descriptive terminology such as, for example, uppermost/lowermost, right/left, front/rear and the like has been adopted for purposes of enhancing the reader's understanding, with respect to the various views provided in the figures, and is in no way intended as been limiting.

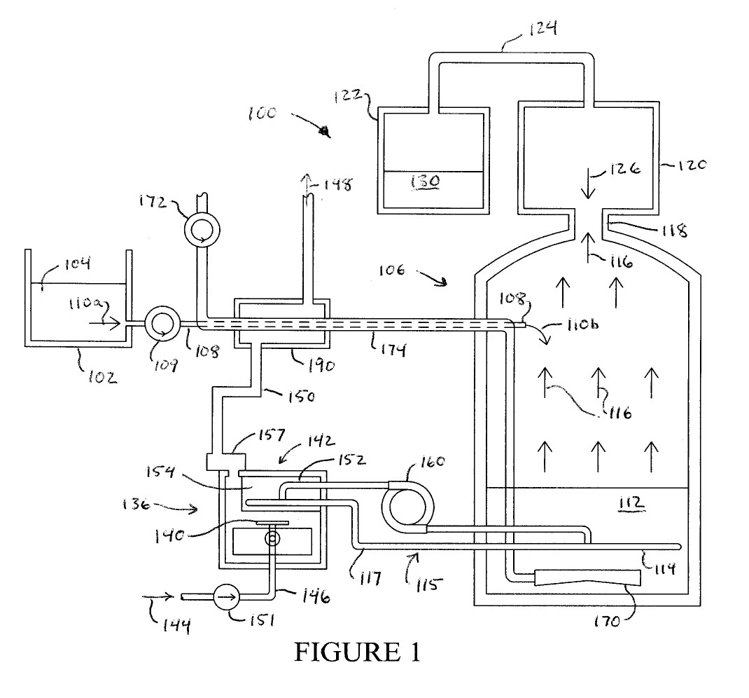

Referring to the drawings, wherein like components may be indicated by like reference numbers throughout the various figures, FIG. 1 illustrates one embodiment of an ethanol production facility, generally indicated by the reference number 100. Facility 100 includes a fermentation tank 102 in which a milled feedstock is mixed with water and enzymes. The enzymes break down starch in the feedstock into simple sugars and the resulting mixture is referred to herein as a mash. Once the sugar has been produced, yeast is added to the mash and the mash ferments in the fermentation tank until the sugars in the feedstock are converted to ethanol and carbon dioxide. Following fermentation, the mix is referred to as a distillant 104 and the ethanol reaches about 15% of the volume. The remaining constituents of distillant 104, other than ethanol, are referred to as stillage and include water and solids. The solids are at least partially dissolved in the water and can include remaining feedstock material along with residual sugars, yeast and yeast waste. The dissolved solids are typically about 10 to 15% of the volume of the stillage.

Distillant 104 is transferred to a distillation column or tank 106 through a distillant supply pipe 108 as represented by arrows 110a and 110b. The distillant leaves the fermentation tank following arrow 110a and enters the distillation tank from the end of the supply pipe as shown by arrow 110b. The distillant leaving the fermentation tank is at a temperature of about 75 to 80 degrees Fahrenheit. The distillant is moved through the pipe using a distillant transfer pump 109. Distillation tank 106 includes a housing 107 that is insulated to retain heat. In this embodiment, the distillant flows into distillation tank 106 where it runs down to the bottom of the tank and collects in pool 112. At this point, the distillant is heated by a heating coil 114 that is submerged in pool 112 and which forms a first portion of a heat transfer tubing 115. Heat provided by heating coil 114 is used in boiling the distillant to separate ethanol from the distillant. The heat vaporizes ethanol, as represented by arrows 116, which rises in the distillation tank until it exits the tank through a stack 118 to a condenser 120. The condenser condenses the ethanol and passes the condensed ethanol to a storage tank 122 through a condenser tube 124 where the ethanol is stored for later use. Stored ethanol 130 in the present embodiment is about 95% ethanol and 5% water. The remaining water can be removed from the ethanol by further steps that are not shown.

The heating in the distillation tank also vaporizes some of the water which also leaves the distillation tank through stack 118 and passes into the condenser. The ethanol and water from the distillant starts to boil off from the distillant at about 174 degrees Fahrenheit. The temperature in the distillation tank can be maintained by the heating oil generally in the range between 174 and 190 F, inclusively. A portion of the water is condensed in the condenser and returns to the distillation tank as reflux, represented as arrow 126. In the present example, distillation tank 106 is constructed with a double wall structure with a refractory material in between the two walls. The refractory material can be fireclay, silica, dolomite, magnesite, alumina, chromite, silicon carbide, carbon or other refractory material. This insulation arrangement retains a larger percentage of heat in the distillation tank relative to conventional insulation techniques such as an externally applied thermal blanket. The two wall refractory arrangement is believed to contain up to 95% of the heat for the distillation process and is capable of holding temperatures up to about 3,000 degrees F.

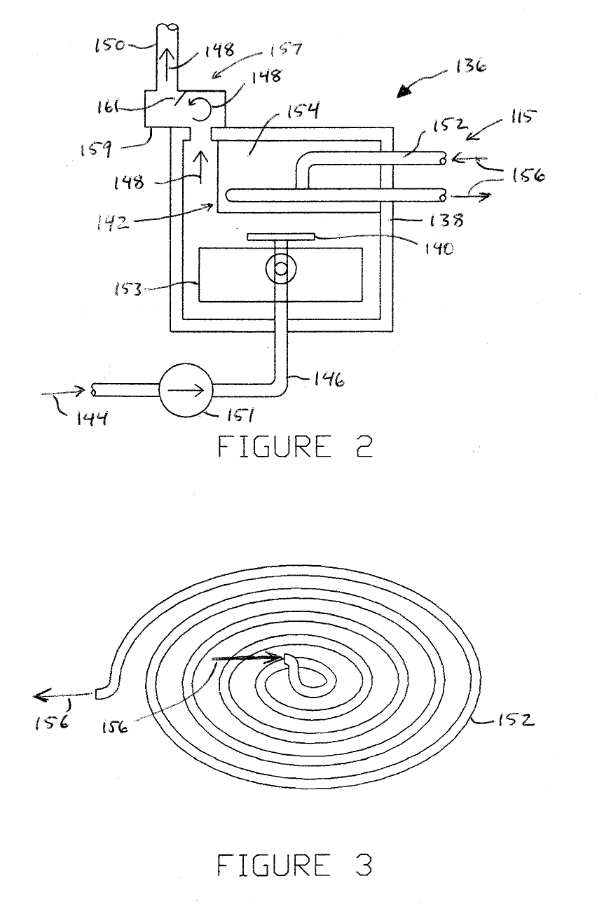

Heat is generated with a burner assembly 136 for heating the distillant in the distillation tank using heat transfer tubing which carries heating oil between the burner assembly and the distillation tank. In conventional production facilities, especially relatively smaller facilities, burners are located at the bottom of the distillation tank where heat from the burner is applied directly to the tank bottom. Burner assembly 136, as detailed in FIG. 2, includes an insulated housing 138 which contains a burner 140 and a heat absorber 142. In the present embodiment, the housing is constructed with two walls having a refractory material between the walls. This arrangement provides an insulating capability which should also eliminate up to 95% of the heat transfer through the walls of the burner assembly.

Fuel 144, represented by an arrow, is supplied to burner 140 through a fuel supply line 146 where the fuel is ignited to create heat. The heat from the burner is used to heat the heat absorber which then transfers the heat to the distillant in the distillation tank. Hot exhaust gas 148 resulting from the burned fuel, represented by an arrow, passes from the insulated housing through a flue 150. The fuel can be propane, natural gas, heating oil, wood pellets, solar, electric resistance, or any suitable heat source. Burner 140 can be replaced or modified as needed to utilize any of these fuel options. By using the indirect heating method using a burner assembly that does not directly heat the distillation tank, the use of alternative heat sources such as solar energy is made possible.

A fuel supply valve 151 is connected in the fuel supply line to control the flow of fuel to the burner. Combustion air is provided to the burner through a window 153 in the insulated housing which opens to the atmosphere, in the present embodiment, however combustion air can also be provided from other sources. The temperature of the burner assembly and the resulting temperature of the heat energy transferred to the distillation tank from the burner assembly is at least partially controlled by the fuel supply valve. Relatively increased amounts of fuel supplied through the valve result in higher levels of heat, while relatively decreased amounts of fuel supplied through the valve result in lower levels of heat. The fuel supply can be controlled manually or automatically and in either case can be controlled based on the temperature within the distillation tank.

Flue 150 includes a baffle assembly 157 which has a baffle housing 159 and a baffle 161. Baffle assembly 157 is used for increasing the amount of time that the hot exhaust gas remains in the burner assembly. This increases the amount of heat from the exhaust that is absorbed by the heat absorber, thereby increasing the efficiency of the ethanol production facility.

Referring to FIG. 3 in conjunction with FIG. 2, the burner is used for heating the heat absorber in the burner assembly. The heat absorber in the present embodiment includes a heat absorber coil 152 made from a second portion of heat transfer tubing 115, and a heat moderating material 154 (FIG. 2). One suitable embodiment of the shape of heat absorber coil 152 is shown in more detail in FIG. 3. The burner heats the heat moderating material which, in turn, heats the heat absorber coil. A heating oil 156, represented by arrows in FIGS. 2 and 3, absorbs heat through the heat absorber coil and circulates the heating oil through the heat transfer tubing 115 including the first and second portions in the distillation tank and the burner, respectively. The heated oil is transferred between the burner assembly and the distillation tank using a transfer tubing 117 portion (FIG. 1) of heat transfer tubing 115. The heat transfer tubing can be insulated in passing between the burner assembly and the distillation tank to reduce heat loss.

Heated oil in heat absorber coil 152 is pumped by a pump 160 to heating coil 114 in the distillation tank where the heat from the oil is transferred to the coil and from the coil to the distillant. The temperature of the heating oil is typically at or about 300 degrees Fahrenheit and pump 160 is one that is able to handle this temperature, such as a magnetic drive centrifugal pump. In one embodiment, the heat absorber coil, and heating coil 114 are made from copper to facilitate heat transfer to and from the heating oil. In another embodiment, transfer tubing 117 is made using ceramic tubing to reduce heat loss between the burner assembly and the distillation tank. The transfer tubing can also be insulated to reduce heat loss.

Heat absorber coil 152 is substantially surrounded by heat moderating material 154. The heat moderating material shown in detail in FIG. 2 is a mortar clay bed. The heat moderating material absorbs the heat energy from the burner and transfers the heat to the heat absorber coil. The heat moderating material ensures that the heat from the burner does not concentrate heat on any one portion of the heat absorber coil. The heat moderating material moderates the heat by distributing the heat around the surface of the heat absorber coil. By moderating and distributing the heat, the material provides for better heat absorption by the heat absorber coil while decreasing the possibility that concentrated heat from the burner will damage the heat absorber coil.

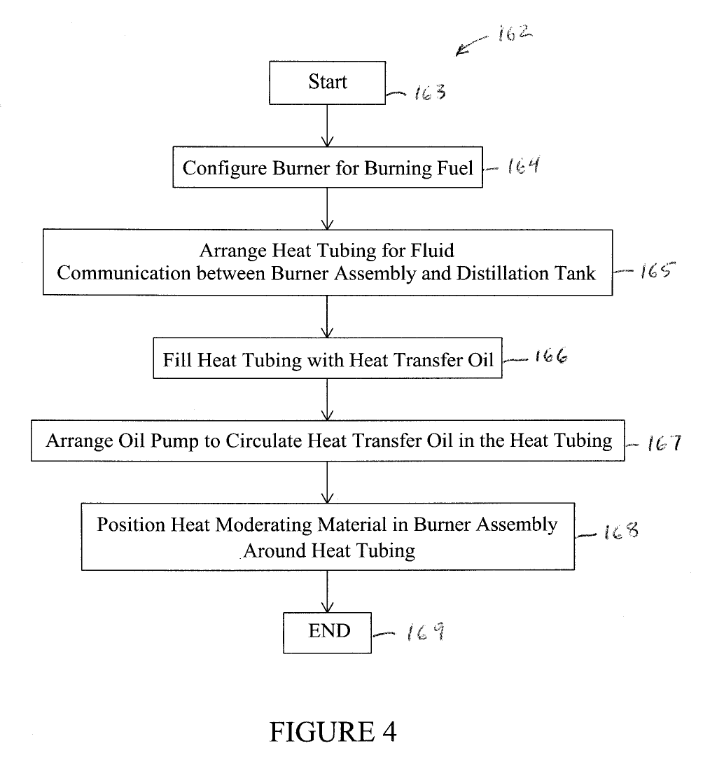

A method 162 for heating the distillation tank in an ethanol production facility is shown in FIG. 4. Method 162 starts at step 163, from which it proceeds to step 164 where a burner assembly is configured for burning fuel to produce heat. From step 164 the method proceeds to step 165 where heat tubing is arranged at least to provide fluid communication between the burner assembly and the distillation tank. The tubing having a tubing wall and defines a through passage. A first portion of the heat tubing is positioned in the distillation tank and another, second portion of the heat tubing is positioned in the burner assembly. Following step 165, method 162 proceeds to step 166 where the heat tubing is filled with heat transfer oil. The heat transfer oil receives heat from the burner assembly through the tubing wall of the second portion of the tubing. The oil transfers the heat to the distillation tank via the through passage such that the heat is transferred into the distillation tank by passing through the tubing wall of the first portion of tubing. After step 166, the method 162 proceeds to step 167 where an oil pump is arranged for pumping the heat transfer oil through the through passage to circulate the heat transfer oil in the through passage. After step 167, the method 162 proceeds to step 168 where a heat moderating material is positioned in the burner assembly in a position to at least partially surround the second portion of the heat tubing. The heat moderating material having a characteristic which causes the heat from the burned fuel to be moderated by distributing the heat in the moderating material and transferring a portion of the heat through the moderating material to the surrounding heat tubing and the heat transfer oil within the surrounded heat tubing. After step 168, the method 162 ends at step 169.

Stillage from the distillant settles near the bottom of the distillation tank. In an embodiment shown in FIG. 1, a stillage collection box 170 is located toward the bottom of the distillation tank at a position to collect the stillage. A stillage pump 172 pulls the stillage from the bottom of the distillation tank through a stillage removal pipe 174 to storage or to other machinery for further processing, not shown in FIG. 1.

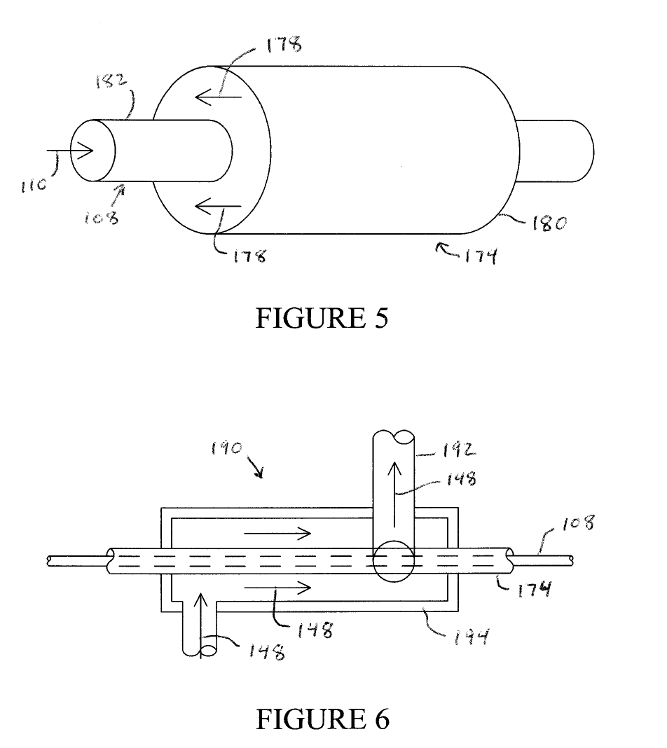

In a heat transfer portion of stillage removal pipe 174, pipe 174 surrounds a portion of distillant supply pipe 108, as detailed in FIG. 5, where the flowing stillage is represented by arrows 178 and the flowing distillant is represented by an arrow 110. In FIG. 1, the surrounded portion of the distillant supply pipe is indicated using dashed lines.

Referring now to FIG. 5 in conjunction with FIG. 1, the stillage passes between a wall 180 of stillage removal pipe 174 and a wall 182 of distillant supply pipe 108 in the heat transfer portion. The walls can be concentric, as shown, but this is not a requirement. Since the stillage is at the bottom of the distillation tank near heating coil 114, the stillage contains a considerable amount of heat, typically at between 174 and 190 degrees F. Heat from the stillage passes through the wall of the distillant supply pipe and preheats the distillant before the distillant reaches the distillation tank. The stillage leaves the heat transfer portion at approximately 120 to 140 degrees F. Using the heat from the stillage to preheat the distillant recaptures heat energy that would otherwise be lost as heat waste if the stillage were to be allowed to cool without transferring the heat to a useful purpose.

In one embodiment, the stillage removal pipe can be 1″ in diameter and the distillant supply pipe can be ⅜″ in diameter copper tubing. The stillage flow rate can be about 83% of that of the distillant flow rate. Because of the larger diameter of the stillage removal pipe the stillage flows slower than the distillant which allows for the heat from the stillage to build up around the distillant supply pipe.

In another embodiment, exhaust 148 from the burner assembly is supplied to a heat exchanger 190. Heat exchanger 190, as shown in FIG. 1 and detailed in FIG. 6, receives exhaust gas 148 through flue 150 and the exhaust gas exits the heat exchanger at exchanger chimney 192. Heat exchanger 190 includes a housing 194 which surrounds a portion of heat transfer portion 176 of stillage removal pipe 174. In one embodiment, the heat exchanger can be 4″ high by 14.5″ wide and 4″ deep. The exhaust temperature can be between 190 and 300 degrees F. depending on the stage of the process. The exhaust temperature will be hotter when inside the burner assembly.

Since stillage removal pipe 174 surrounds the distillant supply pipe 108 in this area, heat exchanger 190 surrounds both of these. Hot exhaust gas 148 from the burner assembly passed is through the heat exchanger along the outer surface of wall 180 (FIG. 5) of the stillage removal pipe 174 where heat from the exhaust is transferred to wall 180. The heated wall 180 transfers this heat to the stillage which transfers the heat to the distillant in the distillant supply pipe. Taking heat from the exhaust and using it to preheat the distillant reduces the amount of heat that must be provided to boil the distillant in the distillation tank. This reduces the amount of fuel that must be burned in the burner assembly to heat the distillant in the distillation tank and thereby reduces fuel consumption and the cost of operating the production facility by reducing heat waste.

The use of the arrangement shown including the heat exchanger and the heat transfer portion of the stillage removal pipe should increase the temperature of the distillant from the fermentation tank from about 75 degrees F. to about 165 degrees F. This is a typical increase of about 70 to 85 degrees F. in the distillant temperature using heat that may otherwise be wasted. While the heat exchanger shown in FIGS. 1 and 6 is positioned to preheat the distillant through the stillage removal pipe, this is not the only embodiment for accomplishing this preheating technique. In other embodiments, the heat exchanger can be arranged to flow the exhaust gas directly over the distillant supply pipe and can be used with or without using the stillage for preheating the distillant.

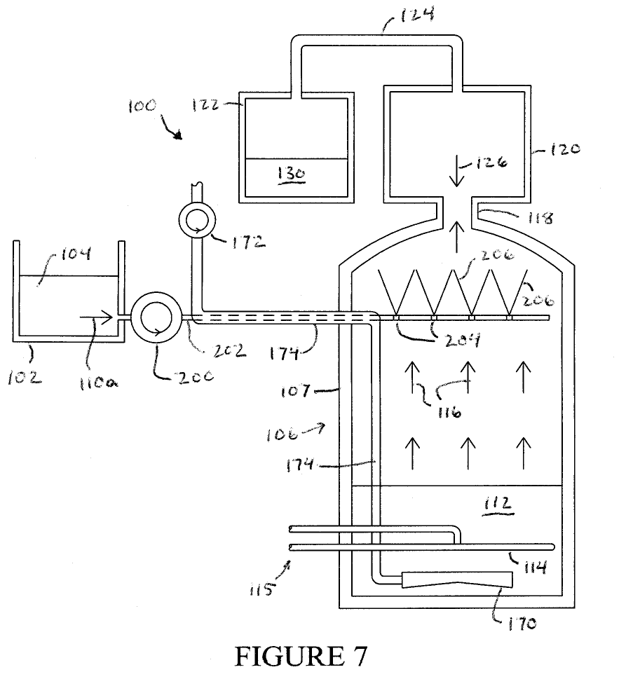

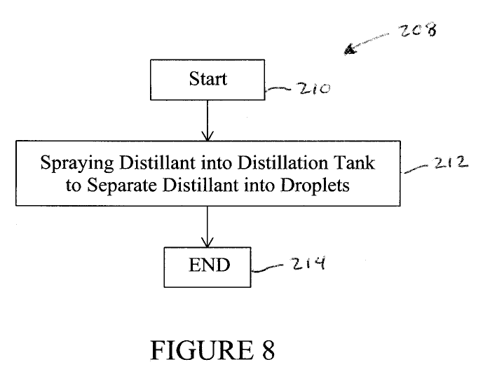

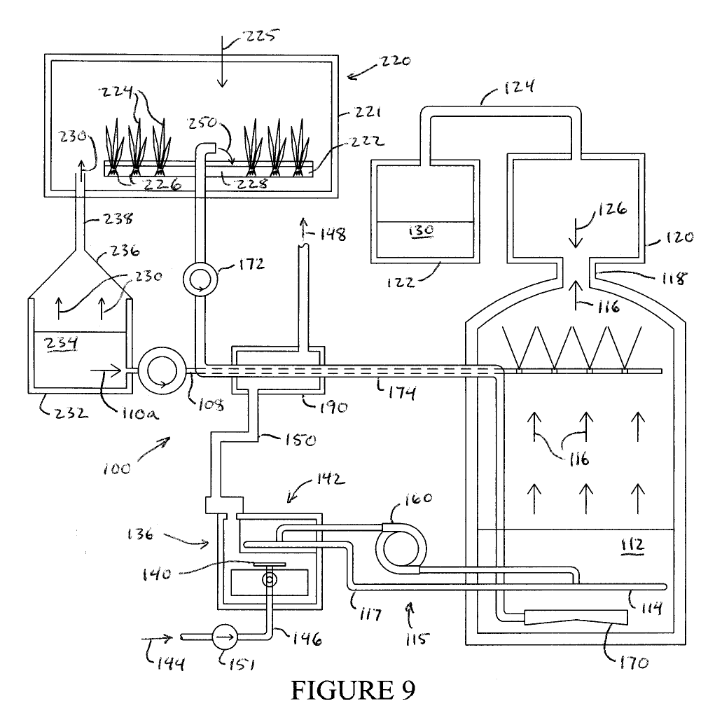

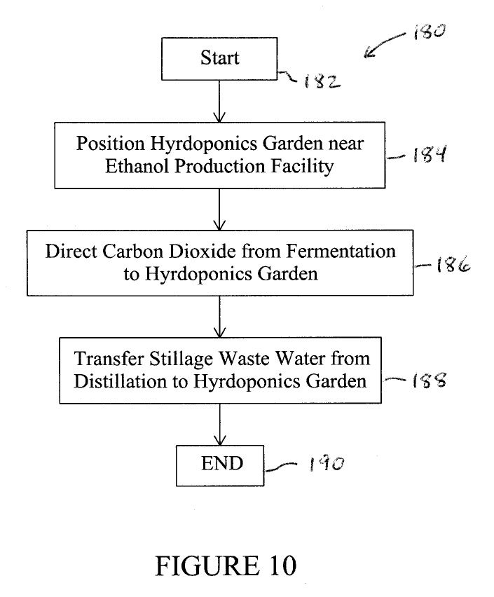

Another unique feature of our embodiment of an ethanol distillation facility is shown in FIG. 7 where distillant 104 is supplied to distillation tank 106 under pressure. Distillant 104 is pressurized in this instance using a distillant pump 200. Pressurized distillant 104 is supplied to the distillation tank through a distillant supply tube 202 that extends horizontally into the tank at a position between stack 118 and heating coil 114. Supply tube 202 includes nozzles 204 which form the distillant into a spray 206 when the distillant is introduced into the distillation tank using the pressure created by distillant pump 200. Distillant pump 200 is large enough to force the distillant through the nozzles by atomizing the distillant causing the distillant form small droplets. The nozzles can be arranged to spray the distillant in patterns, such as a fan or cone pattern, or in a more random spray. Holes in the nozzles are configured large enough to pass solids in the distillant without significant clogging at the pressure provided by distillant pump 200 to serve as a self-cleaning function. In one embodiment, the nozzles are holes formed in the supply tube, these holes can be approximately one-eighth of an inch in diameter.

Distillant pump 200 is sized to pressurize the distillant to the point where it can be sprayed. Transfer pumps, such as transfer pump 109 (FIG. 1) used for moving the distillant from the fermentation tank to the distillation tank in non-spraying type production facilities are not sized to provide the pressure needed for spraying the distillant. In the present example, the distillant is sprayed upward, however, the distillant can also be sprayed horizontally, downward or other directions or combinations of directions. By spraying the distillant into the distillation tank, the distillant more readily absorbs heat, especially in the air in the tank, and the ethanol in the distillant is vaporized more quickly. This is caused, at least partially, because of the increase in surface area for a given amount of distillant that is achieved by breaking the distillant into small droplets. The relatively greater surface area exposes more of the distillant directly to heat than is otherwise accomplished when the distillant is poured into the distillation tank. The sprayed distillant makes better use of the heat available in the distillation tank, thereby making the distillation of the distillant more efficient and reducing costs over conventional systems. It is estimated that spraying the distillant into the distillation chamber can make use of 95% of the heat introduced as compared with 30% in traditional distillation units.

In another embodiment, the distillant can be pumped into the heat exchanger where the distillant will begin to expand due to the increase in temperature. The expansion of the distillant will increase the pressure in the distillant supply pipe until the distillant reaches the nozzles where the distillant is then sprayed into the distillation tank. By using a system of preheating and spraying the distillant, the efficiency of the production facility is estimated to increase by 25% or more as compared with a similarly sized facility that does not use these techniques, where efficiency is determined by the rate of ethanol production.

One method 208, shown in FIG. 8, starts at a start 210 and then proceeds to a step 212 where distillant is sprayed into the distillation tank to cause the distillant to be separated into droplets which have an increased surface area per volume relative to a non-sprayed distillant of the same volume. The increased surface area of the droplets causes an increase in the absorption of the applied heat relative to the non-sprayed distillant and thereby increases the amount of ethanol that is separated from the distillant for a given amount of heat applied in the distillation tank. Following step 212, the method ends at step 214.

Another unique feature of an ethanol production facility is illustrated in FIG. 9 where the facility is integrated with a hydroponics garden 220.

Hydroponics garden 220 is positioned at a location near the ethanol production facility. Garden 220 includes an enclosure 221 which at least partially encloses one or more plant trays 222. The enclosure in the present example includes a section 223 that is substantially transparent to allow sunlight 225 to enter the enclosure. The plant trays each contain plants 224 having roots 226 that are at least partially submerged in a root immersion water 228. The plants grow using carbon dioxide, sunlight and nutrients provided along with the root immersion water. The enclosure does not have to have a transparent section to allow sunlight and can instead have one or more grow lights that provide light in the necessary spectrum for use in photosynthesis, or a combination of natural sunlight and grow lights can be used.

In this example, carbon dioxide 230, represented by arrows is created when the yeast in fermentation tank 232 converts sugar in mash 234 into ethanol. The carbon dioxide is collected from the fermentation tank using a collector 236 which directs the carbon dioxide into a carbon dioxide transfer duct 238.

Transfer duct 238 directs the carbon dioxide produced in the fermentation tank to the interior of the hydroponics enclosure where it is available for plants 224. Plants use carbon dioxide for photosynthesis using energy provided by sunlight 225 to produce oxygen for release into the atmosphere. By providing the carbon dioxide from the fermentation to the plants in the hydroponics garden, the carbon dioxide is not released into the atmosphere and does not have to be captured, stored and transported for use in other industries. This arrangement is especially beneficial in smaller ethanol production facilities which produce amounts of carbon dioxide that would not be economical to capture and sell for other uses.

Waste water in the form of stillage has beneficial use in the hydroponics garden. In the embodiment shown in FIG. 9 stillage 250, represented by arrows is directed from distillation tank 252 to the hydroponics garden through a stillage pipe 254. The temperature of the stillage is reduced by preheating the distillant or by some other method. The stillage is then supplied to the plant trays for use as the root immersion water. One of the benefits of using the stillage as the root immersion water is that the stillage can be used without removing anything and nutrients can be added to the stillage based on the original feedstock and the needs of the plants in the garden.

In larger conventional ethanol production facilities, the water in the stillage must be reclaimed before effluent is discharged into a sewer system. Using the stillage as the root immersion water reduces or eliminates what would otherwise be a waste product in ethanol production.

A method 180, shown in FIG. 10, begins at a start step 182. Method 180 involves reducing waste from an ethanol production facility in which sugar containing raw material is fermented to produce ethanol. The ethanol production produces waste materials including carbon dioxide, and stillage including waste water and solids. From step 182 method 180 proceeds to step 184 where a hydroponics garden is positioned in a location near the ethanol production facility. The hydroponics garden has a structure that is at least partially enclosed and which contains plants that are arranged with roots that are at least partially immersed in a root immersion water. From step 184, method 180 proceeds to step 186 where at least a portion of the carbon dioxide produced by the fermentation is directed into the hydroponics structure for use by the plants during photosynthesis. Following step 184, method 180 proceeds to step 188 where at least a portion of the stillage waste water is transferred to the hydroponics garden for use as the root immersion water. Following step 188, method 180 ends at step 190.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. In an ethanol production facility in which a sugar containing raw material is fermented to produce a distillant containing ethanol and stillage and where the distillant is introduced into a distillation tank where heat is applied to the distillant to remove ethanol from the distillant by vaporizing the ethanol which is then removed from the distillation tank, a method for increasing the amount of ethanol that is removed from the distillant for a given amount of heat applied in the distillation tank, said method comprising:
spraying the distillant into the distillation tank to cause the distillant to be separated into droplets which have an increased surface area per volume relative to a non-sprayed distillant of the same volume, the increased surface area of the droplets causing an increase in the absorption of the applied heat relative to the non-sprayed distillant thereby increasing the amount of ethanol that is separated from the distillant for a given amount of heat applied in the distillation tank.

2. A method as defined in claim 1, further comprising:
pressurizing the distillant prior to spraying the distillant into the distillation tank, where the pressurizing at least partially contributes to atomization of the distillant.

3. A method as defined in claim 1, further comprising:
preheating the distillant prior to spraying the distillant into the distillation tank to reduce the amount of heat needed to be provided in the distillation tank to remove a given amount ethanol from the distillant.

4. A method as defined in claim 3 wherein the stillage absorbs heat in the distillation tank, the method further comprising:
using at least a portion of the stillage heat for preheating the distillant.

5. A method as defined in claim 3 wherein the distillation tank is heated using a burner assembly which produces a hot exhaust gas, the method further comprising:
using at least a portion of the exhaust gas heat for preheating the distillant.

6. A method as defined in claim 3 wherein preheating the distillant includes preheating the distillant to about 160 degrees Fahrenheit.

7. A method as defined in claim 3 wherein the distillant has an initial, non-preheated, temperature and the method further comprises:
preheating the distillant to increase the initial temperature by 70 to 85 degrees Fahrenheit.

8. A method as defined in claim 1 wherein the distillation tank is heated using heat tubing positioned below a location where the distillant is sprayed into the distillation tank and the sprayed distillant falls from the spray location toward the heat tubing, and heat in air in the distillation tank vaporizes a first portion of the ethanol while the distillant is falling from the spray location and a second portion of the ethanol is vaporized by absorbing heat through contact with the heat tubing.

9. A method as defined in claim 1 wherein the distillation tank includes a heat source for introducing heat into the distillation tank to vaporize the ethanol and the distillation tank also includes a stack at a top position of the distillation tank where the vaporized ethanol is removed from the distillation tank through the stack, and wherein spraying the distillant includes spraying the distillant at a position below the stack and above the heat source in the distillation tank.

10. A method as defined in claim 1 where the stillage includes water and solids and the distillant is carried into the distillation tank in a distillant tube having a wall and defining a through passage, and wherein spraying the distillant includes spraying the distillant into the distillation tank through at least one nozzle that is in fluid communication with the distillant tube, where the nozzle is sized to allow for the passage of the stillage solids while spraying the water and ethanol.

11. A method as defined in claim 10 further comprising:
defining at least one spray hole in the wall of the distillant tube for use as the nozzle.

12. A method as defined in claim 10 further comprising:
arranging the nozzle to make the distillant spray in a generally fan shaped pattern.

13. A method as defined in claim 10 further comprising:
arranging the nozzle to make the distillant spray in a generally cone shaped pattern.

14. A method for reducing waste from an ethanol production facility in which a sugar containing raw material is fermented to produce ethanol, the ethanol production also producing waste materials including carbon dioxide, and stillage including waste water and solids, said method comprising:
positioning at least one hydroponics garden in a location near the ethanol production facility, the hydroponics garden having a structure that is at least partially enclosed and which contains plants arranged having roots at least partially immersed in a root immersion water;
directing at least a portion of the carbon dioxide produced by the fermentation into the hydroponics structure for use by the plants during photosynthesis; and
transferring at least a portion of the stillage waste water to the hydroponics garden for use as the root immersion water.

15. A method as defined in claim 14, wherein the ethanol production facility introduces a distillant into a distillation tank to remove ethanol from the distillant using heat in the distillation tank provided by a burner assembly, the method further comprising:
before said transferring of the waste water, using heat from the waste water to pre-heat a distillant prior to the introduction of the distillant into the distillation tank to decrease an amount of heat needed by the burner assembly to remove the ethanol.

16. A method as defined in claim 14, wherein the waste water is transferred to the hydroponics garden without removing any substances from the waste water.

17. A method for heating a distillation tank in an ethanol production facility, comprising:
configuring a burner assembly for burning a fuel to produce heat;
arranging heat tubing at least to provide fluid communication between the burner assembly and the distillation tank, said tubing having a tubing wall and defining a through passage, where a first portion of the heat tubing is positioned in the distillation tank and another, second portion of the heat tubing is positioned in the burner assembly;
filling the heat tubing with a heat transfer oil, the heat transfer oil for receiving heat from the burner assembly transferred through the tubing wall of the second portion of the tubing and for transferring the heat to the distillation tank via said through passage such that the heat is transferred into the distillation tank by passing through the tubing wall of the first portion of tubing;
arranging an oil pump for pumping the heat transfer oil through the through passage to circulate in the through passage; and
positioning a heat moderating material in the burner assembly in a position to at least partially surround the second portion of the heat tubing, the heat moderating material having a characteristic which causes the heat from the burned fuel to be moderated by distributing the heat in the moderating material and transferring a portion of the heat through the moderating material to the surrounded heat tubing and the heat transfer oil within the surrounded heat tubing.

18. A method as defined in claim 17, wherein the distillation tank uses the heat from the first portion of tubing to remove ethanol from a distillant and wherein the burning of the fuel produces exhaust gas containing heat energy, the method further comprising:
directing the exhaust gas to preheat the distillant to reduce the amount of heat required to be provided by the first portion of tubing to remove a given amount of ethanol from the distillant.

19. A method as defined in claim 17, wherein the distillation tank uses the heat from the first portion of tubing to remove ethanol from a distillant which includes ethanol and stillage and where the stillage is heated by the first portion of tubing during the removal of the ethanol from the distillant, the method further comprising:
directing the stillage to preheat the distillant to reduce the amount of heat required to be provided by the first portion of tubing to remove a given amount of ethanol from the distillant.

20. A method as defined in claim 17 wherein positioning a heat moderating material includes positioning mortar clay.

21. A method as defined in claim 17 wherein the heat tubing is arranged with ceramic.

22. A method as defined in claim 17 wherein the heat tubing is arranged with copper.

23. In an ethanol production facility in which a sugar containing raw material is fermented to produce a distillant containing ethanol and stillage and where the distillant is introduced into a distillation tank where heat is applied to the distillant to remove ethanol from the distillant by vaporizing the ethanol which is then removed from the distillation tank, a distilling device for increasing the amount of ethanol that is removed from the distillant for a given amount of heat applied in the distillation tank, said distilling device comprising:
a distillant sprayer for spraying the distillant into the distillation tank to cause the distillant to be separated into droplets which have an increased surface area per volume relative to a non-sprayed distillant of the same volume, the increased surface area of the droplets causing an increase in the absorption of the applied heat relative to the non-sprayed distillant thereby increasing the amount of ethanol that is separated from the distillant for a given amount of heat applied in the distillation tank.

24. A distilling device as defined in claim 23, further comprising:
a distillation pressurizing pump arranged to pressurize the distillant prior to spraying the distillant into the distillation tank, where the pressurizing at least partially contributes to atomization of the distillant.

25. A distilling device as defined in claim 23, further comprising:
a preheater for preheating the distillant prior to spraying the distillant into the distillation tank to reduce the amount of heat needed to be provided in the distillation tank to remove a given amount ethanol from the distillant.

26. A distilling device as defined in claim 25 wherein the stillage absorbs heat in the distillation tank, and the preheater is arranged to use at least a portion of the stillage heat for preheating the distillant.

27. A distilling device as defined in claim 25 wherein the distillation tank is heated using a burner assembly which produces a hot exhaust gas, and the preheater is arranged to use at least a portion of the exhaust gas heat for preheating the distillant.

28. A distilling device as defined in claim 25 wherein the preheater is arranged to preheat the distillant to about 160 degrees Fahrenheit.

29. A distilling device as defined in claim 25 wherein the distillant has an initial, non-preheated, temperature, and the preheater is arranged to increase the initial temperature by 70 to 85 degrees Fahrenheit.

30. A distilling device as defined in claim 23 wherein the distillation tank is heated using heat tubing positioned at a relatively lower position in the distillation tank and the distillant sprayer is arranged at a position that is relatively higher than the heat tubing such that when distillant is sprayed into the distillation tank, the sprayed distillant falls from the spray location toward the heat tubing.

31. A distilling device as defined in claim 23 wherein the distillation tank includes a heat source for introducing heat into the distillation tank to vaporize the ethanol and the distillation tank also includes a stack at a top position of the distillation tank where the vaporized ethanol is removed from the distillation tank through the stack, and where the distillant sprayer is positioned below the stack and above the heat source in the distillation tank.

32. A distilling device as defined in claim 23 where the stillage includes water and solids and the distillant is carried into the distillation tank in a distillant tube having a wall and defining a through passage, and where the distillant sprayer includes at least one nozzle that is in fluid communication with the distillant tube, where the nozzle is sized to allow for the passage of the stillage solids while spraying the water and ethanol.

33. A distilling device as defined in claim 32 wherein the nozzle is a hole in the outer wall of the distillant tube.

34. A distilling device as defined in claim 32 wherein the nozzle is arranged to spray the distillant in a generally fan shaped pattern.

35. A distilling device as defined in claim 32 wherein the nozzle is arranged to spray the distillant in a generally cone shaped pattern.

36. An ethanol production facility in which ethanol is produced by fermentation of a sugar containing raw material, the ethanol production also producing waste materials including carbon dioxide from fermentation in a fermentation tank, and stillage including waste water and solids in a distillation tank, said facility comprising:
at least one hydroponics garden, the hydroponics garden having a structure that is at least partially enclosed and which contains plants arranged having roots at least partially immersed in a root immersion water;
a carbon dioxide transfer duct connected with the hydroponics structure and the fermentation tank and arranged for directing at least a portion of the carbon dioxide produced by the fermentation into the hydroponics structure for use by the plants during photosynthesis; and
a stillage pipe connected with the hydroponics structure and the distillation tank and arranged for transferring at least a portion of the stillage waste water to the hydroponics garden for use as the root immersion water.

37. An ethanol production facility as defined in claim 36, wherein a distillant which includes ethanol and stillage is introduced into the distillation tank, the facility further comprising:
a burner assembly for providing heat to the distillation tank for use in removing ethanol from the distillant by heating the distillant; and
a preheater arranged to receive the waste water from the distillation tank and to use heat from the waste water to increase the temperature of the distillant prior to the distillant being introduced into the distillation tank to decrease an amount of heat needed by the burner assembly to remove the ethanol from the distillant.

38. An ethanol production facility as defined in claim 36, wherein the stillage pipe is arranged to transfer the waste water to the hydroponics garden without removing any substances from the waste water.

39. A heating arrangement for heating a distillation tank in an ethanol production facility, comprising:
a burner assembly for burning a fuel to produce heat;
a heat tubing at least to provide fluid communication between the burner assembly and the distillation tank, said tubing having a tubing wall and defining a through passage, where a first portion of the heat tubing is positioned in the distillation tank and another, second portion of the heat tubing is positioned in the burner assembly;
a heat transfer oil filling the heat tubing, the heat transfer oil for receiving heat from the burner assembly transferred through the tubing wall of the second portion of the tubing and for transferring the heat to the distillation tank via said through passage such that the heat is transferred into the distillation tank by passing through the tubing wall of the first portion of tubing;
an oil pump for pumping the heat transfer oil through the through passage to circulate in the through passage; and
a heat moderating material in the burner assembly in a position to at least partially surround the second portion of the heat tubing, the heat moderating material having a characteristic which causes the heat from the burned fuel to be moderated by distributing the heat in the moderating material and transferring a portion of the heat through the moderating material to the surrounded heat tubing and the heat transfer oil within the surrounded heat tubing.

40. A heating arrangement as defined in claim 39, wherein the distillation tank uses the heat from the first portion of tubing to remove ethanol from a distillant and wherein the burning of the fuel produces exhaust gas containing heat energy, the heating arrangement further comprising:
a heat exchanger; and
a flue arranged to direct the exhaust gas from the burner assembly to the heat exchanger, the heat exchanger using the exhaust gas to preheat the distillant to reduce the amount of heat required to be provided by the first portion of tubing to remove a given amount of ethanol from the distillant.

41. A heating arrangement as defined in claim 39, wherein the distillation tank uses the heat from the first portion of tubing to remove ethanol from a distillant which includes ethanol and stillage and where the stillage is heated by the first portion of tubing during the removal of the ethanol from the distillant, the heating arrangement further comprising:
a stillage pipe arranged to preheat the distillant to reduce the amount of heat required to be provided by the first portion of tubing to remove a given amount of ethanol from the distillant.

42. A heating arrangement as defined in claim 39 wherein the heat moderating material is mortar clay.

43. A heating arrangement as defined in claim 39 wherein at least a portion of the heat tubing is ceramic.

44. A heating arrangement as defined in claim 39 wherein at least a portion of the heat tubing is copper.

45. A heating arrangement as defined in claim 39 wherein the burner assembly includes a housing that at least partially surrounds the heat moderating material, the housing having a inner and outer walls with a refractory material between the inner and outer walls for insulating the heat produced in the burner assembly from the atmosphere.

46. A heating arrangement as defined in claim 39 wherein the distillation tank includes a double wall structure that includes inner and outer walls with a refractory material between the inner and outer walls for insulating against heat loss from the distillation tank.
